(19) United States
(12) Patent Application Publication
(10) Pub. No.: US 2008/0174827 A1
(43) Pub. Date: Jul. 24, 2008

(54) SYSTEM AND METHOD FOR SECURE SHARING OF DOCUMENT PROCESSING DEVICE CLONING DATA

(76) Inventors: Silvy Wilson, Rancho Santa Margari, CA (US); Fabio Gava, Ladera Ranch, CA (US); Andrey Savov, Fullerton, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,818

(22) Filed: Jan. 24, 2007

(51) Int. Cl. G06K 15/02

(52) U.S. Cl. 358/3.28

(57) ABSTRACT

The subject application is directed to a system and method for secure sharing of configuration cloning information for document processing devices. A document processing device first receives configuration data corresponding to a configuration to be implemented by the document processing device. The document processing device then commences document processing operations in accordance with the received configuration data. The received configuration data is then encrypted using a unique encryption key. Preferably, the encryption key is unique to a node associated with a document processing device. The document processing device then commences the selective transfer of the encrypted configuration data to at least one additional document processing device via the computer network. The receiving document processing device decrypts the encrypted configuration data and then is configured in accordance with the decrypted configuration data.

### BACKGROUND OF THE INVENTION

The subject application is directed generally to a system and method for configuration cloning for document processing devices. In particular, the subject application is directed to a system and method for securely transferring data to devices to allow for cloning of software, setup, or configuration.

A company, university, hospital, or other type of large entity will typically have a number of document processing devices, such as multifunctional peripheral device, available for use by its employees. Each document processing device must be installed and configured according to the needs of the owner. Frequently, many similar devices will be installed in a network. Each device must be periodically updated or configured. In order to maintain or improve the functionality or settings of such document processing devices, there is a frequent need to incorporate revised configuration information, updates, upgrades, maintenance fixes, or aspects to be installed or configured on the devices. One current option for updating the devices of an entity is for an administrator to install such update or reconfiguration information on one device and perform a test to determine the acceptability of such changes. The administrator must then install the update on each additional device. Another option is for the update to be installed on one device for testing, and upon acceptability of the update, an update server distributes the updates to each device.

When a particular setup or configuration is isolated for propagation to other devices, this information must be communicated to each device in a machine readable form. However, such information may be vulnerable to modification or tampering, which could lead to potential security breaches or other undesired consequences for altered information.

### SUMMARY OF THE INVENTION

In accordance with the subject application, there is provided a system and method for configuration cloning for document processing devices.

Further, in accordance with the subject application, there is provided a system and method for continuously updating the configuration of a plurality of networked document processing devices by use of a secure data interchange.

Further, in accordance with the subject application, there is provided a system and method that allows a user to synchronize updating of document processing devices in order to maintain nearly identical configurations of the document processing devices with lessened risk of tampering or alteration of configuration files.

Still further, in accordance with the subject application, there is provided a configuration cloning system for document processing devices. The system includes means adapted for receiving, into at least one document processing device, configuration data representative of a configuration thereof, means adapted for commencing operation of the at least one document processing device in accordance with received configuration data, encryption means adapted for encrypting received configuration data and transfer means adapted for selectively commencing a transfer of encrypted configuration data to at least one additional document processing device via an associated network.

In one embodiment, the system further includes means adapted for transferring received encrypted configuration data to the at least one additional document processing device, decryption means adapted for decrypting received encrypted configuration data and means adapted for configuring the at least one additional document processing device in accordance with decrypted configuration data.

In another embodiment, the system includes means adapted for encrypting received configuration data in accordance with an encryption key unique to a node associated with a document processing device.

In yet another embodiment, the system includes means adapted for encrypting received configuration data for each of the at least one additional document processing devices in accordance with a unique encryption key associated therewith.

Still further, in accordance with the subject application, there is provided a method for configuration cloning for document processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for secure sharing of configuration cloning information for document processing devices according to the subject application;

FIG. 2 is a block diagram illustrating controller hardware for use in the system for secure sharing of configuration cloning information for document processing devices according to the subject application;

FIG. 3 is a functional diagram illustrating the controller for use in the system for secure sharing of configuration cloning information for document processing devices according to the subject application;

FIG. 4 is a block diagram illustrating device hardware for use in the system for secure sharing of configuration cloning information for document processing devices according to the subject application;

FIG. 5 is a functional diagram illustrating the device for use in the system for secure sharing of configuration cloning information for document processing devices according to the subject application;

FIG. 6 is a flowchart illustrating the method for secure sharing of configuration cloning information for document processing devices according to the subject application;

FIG. 7 is a flowchart illustrating the method for secure sharing of configuration cloning information for document processing devices from an encryption point-of-view according to the subject application; and

FIG. 8 is a flowchart illustrating the method for secure sharing of configuration cloning information for document processing devices from a decryption point-of-view according to the subject application.

### DETAILED DESCRIPTION OF THE PREFERRED EMBODIMENT

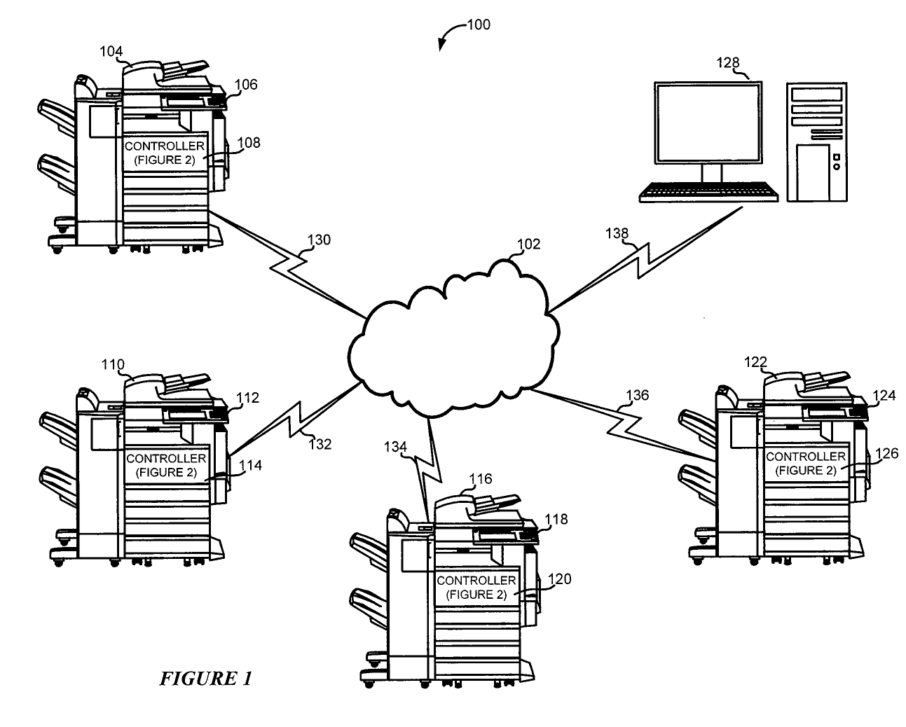

The subject application is directed to a system and method for configuration cloning for document processing devices. In particular, the subject application is directed to a system and method for continuously updating the configuration of a plurality of networked document processing devices by use of a secure data interchange. More particularly, the subject application is directed to a system and method that allows a user synchronized updating of document processing devices in order to maintain nearly identical configurations of the document processing devices with lessened risk of tampering or alteration of configuration files. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for secure sharing of configuration cloning information for document processing devices in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a system wherein each document processing device, explained in greater detail below, is connected, directly or wirelessly, to the next in serial, parallel, or the like, as will be known in the art.

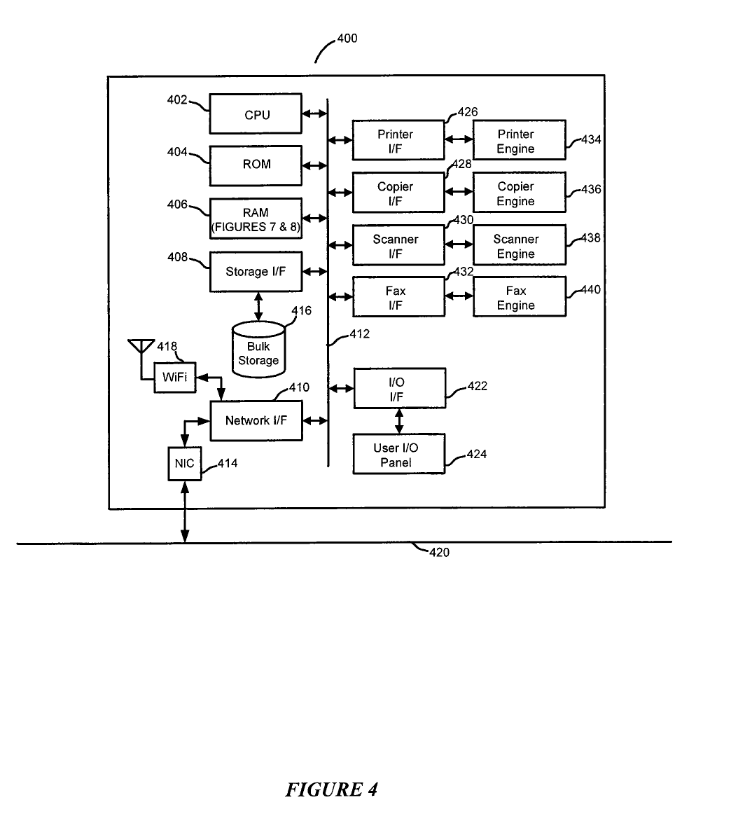

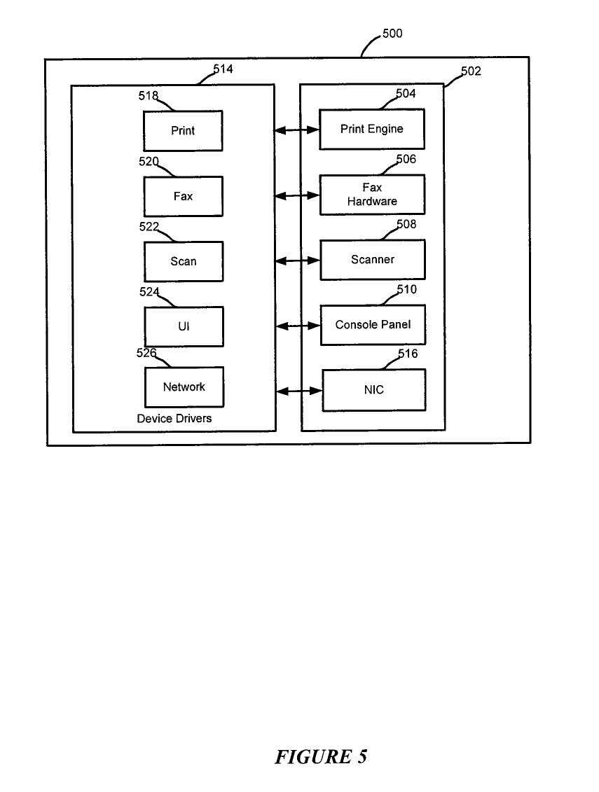

The system 100 also includes a first document processing device 104, a second document processing device 110, a third document processing device 116, and a fourth document processing device 122, each of which are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 110, 116, and 122 are suitably adapted to provide remote document processing services to external or network devices. Preferably, the document processing devices 104, 110, 116, and 122 include hardware, software, and any suitable combination thereof, configured to interact with an associated user, a networked device, each other, or the like. It will be appreciated by those skilled in the art that the subject application that the display of four document processing in the system 100 is for example purposes only, and the subject application is capable of including fewer or greater numbers of devices in accordance therewith. The functioning of the document processing devices 104, 110, 116, and 122 will be explained in greater detail below with respect to FIG. 4 and FIG. 5.

According to one embodiment of the subject application, each document processing device 104, 110, 116, and 122, is suitably equipped to receive a plurality of portable storage media, including, without limitation, Firewire drive, USB drive, SD, MMC, XD, Compact Flash, Memory Stick, and the like. In the preferred embodiment of the subject application, each document processing device 104, 110, 116, and 122 further includes an associated user interface 106, 112, 118, and 124, respectively, such as a touch-screen, LCD display, touch-panel, alpha-numeric keypad, or the like, via which an associated user is able to interact directly with the corresponding document processing device 104, 110, 116, and 122. In accordance with the preferred embodiment of the subject application, each user interface 106, 112, 118, and 124 is advantageously used to communicate information to the associated user and receive selections from the associated user. The skilled artisan will appreciate that the user interfaces 106, 112, 118, and 124 comprise various components, suitably adapted to present data to the associated user, as are known in the art. In accordance with one embodiment of the subject application, the user interfaces 106, 112, 118, and 124 comprise a display, suitably adapted to display one or more graphical elements, text data, images, or the like, to an associated user, receive input from the associated user, and communicate the same to a backend component, such as the controllers 108, 114, 120, and 126, as explained in greater detail below. Preferably, the document processing devices 104, 110, 116, and 122 are communicatively coupled to the computer network 102 via suitable communications links 130, 132, 134, and 136, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

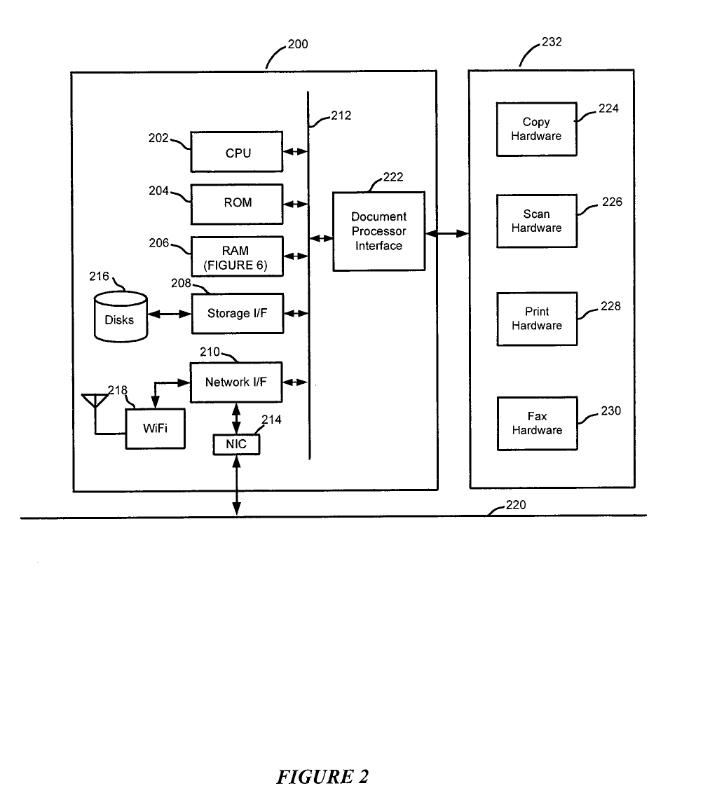

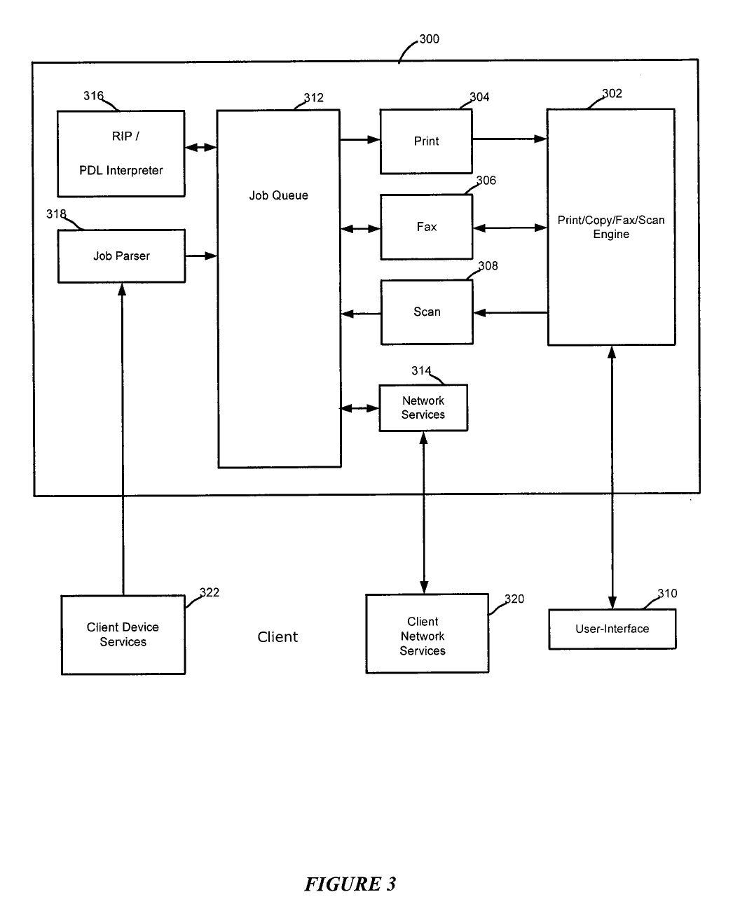

In accordance with the subject application, each document processing device 104, 110, 116, and 122 further incorporates a suitable backend component, designated as controllers 108, 114, 120, and 126, respectively, suitably adapted to facilitate the operations of the associated document processing devices 104, 110, 116, and 122, as will be understood by those skilled in the art. Preferably, the controllers 108, 114, 120, and 126 are embodied as hardware, software, or any suitable combination thereof, configured to control the operations of the corresponding document processing device 104, 110, 116, and 122, facilitate the display of images via the corresponding user interface 106, 112, 118, and 124, direct the manipulation of electronic image data, and the like. For purposes of explanation, the controllers 108, 114, 120, and 126 are used to refer to any myriad of components associated with the document processing devices 104, 110, 116, and 122, including hardware, software, or combinations thereof, functioning to perform, cause to be performed, control, or otherwise direct the methodologies described hereinafter. It will be understood by those skilled in the art that the methodologies described with respect to the controllers 108, 114, 120, and 126 are capable of being performed by any general purpose computing system, known in the art, and thus the controllers 108, 114, 120, and 126 are representative of such a general computing device and are intended as such when used hereinafter. Furthermore, the use of the controllers 108, 114, 120, and 126 hereinafter is for the example embodiment only, and other embodiments, which will be apparent to one skilled in the art, are capable of employing the system and method for secure sharing of configuration cloning information for document processing devices in accordance with the subject application. The functioning of the controllers 108, 114, 120, and 126 will better be understood in conjunction with the block diagrams illustrated in FIGS. 2 and 3, explained in greater detail below.

It will be appreciated by those skilled in the art that while not shown in FIG. 1, each document processing device 104, 110, 116, and 122 is capable of being in data communication with a suitable mass storage device, wherein configuration data, user settings, passwords, documents, account information, or the like is stored. The skilled artisan will appreciate that such a mass storage device (not shown), is capable of being connected to the network 102 and thereby shared amongst the devices 104, 110, 116, and 122, or a separate storage device communicatively coupled to each respective device 104, 110, 116, and 122. As will be understood by those skilled in the art, suitable mass storage devices include, for example and without limitation, magnetic storage drives, a hard disk drive, optical storage devices, flash memory devices, or any suitable combination thereof. In accordance with one embodiment of the subject application, each document processing device 104 110, 116, and 122 implements a storage device in the form of an internal hard disk drive, or the like.

The system 100 illustrated in FIG. 1 further depicts an administrator device 128, in data communication with the computer network 102 via a communications link 138. It will be appreciated by those skilled in the art that the administrator device 128 is shown in FIG. 1 as a desktop computer for illustration purposes only. As will be understood by those skilled in the art, the administrator device 128 is representative of any personal computing device known in the art, including, for example and without limitation, a computer workstation, a laptop computer, a personal data assistant, a web-enabled cellular telephone, a smart phone, a proprietary network device, or other web-enabled electronic device. The communications link 138 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrator device 128 is suitably adapted to retrieve, modify, update, delete, or transfer configuration data to one or more document processing devices 104, 110, 116, and 122, via the computer network 102. In accordance with one embodiment of the subject application, the administrator device 128 is suitably used to generate an XML document comprising configuration data corresponding to the configuration of a document processing device 104, 110, 116, or 122 coupled to the computer network 102. In such an embodiment, the administrator device 128 is capable of transferring the configuration data to a first document processing device 104, 110, 116, or 122 via the computer network 102, transferring the configuration data to a removable storage media for transfer to a selected document processing device 104, 110, 116, or 122, or the like.

Turning now to FIG. 2, illustrated is a representative architecture of a suitable backend component, i.e., the controller 200, representative of each controller 108, 114, 120, and 126 shown in FIG. 1, on which operations of the subject system 100 are completed. The skilled artisan will understand that the controllers 108, 114, 120, and 126 are representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device 104, 110, 116, and 122 that includes the controller 200 of FIG. 2, (shown in FIG. 1 as the controllers 108, 114, 120, and 126), as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These devices facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between the job queue 312 and the network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable device 400 (representative of the devices 104, 110, 116, and 122 of FIG. 1) on which operations of the subject system 100 are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by processor 402.

A storage interface 408 suitably provides a mechanism for volatile, bulk or long term storage of data associated with the device 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the device 400 to communicate to other devices. Network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and network subsystem 410 is suitably accomplished via a bus data transfer mechanism, such as illustrated by bus 412.

Suitable executable instructions on the device 400 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 422 to a user input/output panel 424 as will be appreciated by one of ordinary skill in the art.

Also in data communication with bus 412 are interfaces to one or more document processing engines. In the illustrated embodiment, printer interface 426, copier interface 428, scanner interface 430, and facsimile interface 432 facilitate communication with printer engine 434, copier engine 436, scanner engine 438, and facsimile engine 440, respectively. It is to be appreciated that the device 400 suitably accomplishes one or more document processing functions. Systems accomplishing more than one document processing operation are commonly referred to as multifunction peripherals or multifunction devices.

Turning now to FIG. 5, illustrated is a suitable document processing device 500 for use in connection with the disclosed system. FIG. 5 illustrates suitable functionality of the hardware of FIG. 4 in connection with software and operating system functionality as will be appreciated by one of ordinary skill in the art. The document processing device 500 suitably includes an engine 502 which facilitates one or more document processing operations.

The document processing engine 502 suitably includes a print engine 504, facsimile engine 506, scanner engine 508 and console panel 510. Print engine 504 allows for output of physical documents representative of an electronic document communicated to the processing device 500. Facsimile engine 506 suitably communicates to or from external facsimile devices via a device, such as a fax modem.

A scanner 508 suitably functions to receive hard copy documents and in turn image data corresponding thereto. A suitable user interface, such as the console panel 510, suitably allows for input of instructions and display of information to an associated user. It will be appreciated that the scanner 508 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 5, the document processing engine 502 also comprises an interface 516 with a network, via driver 526, suitably comprised of a network interface card. It will be appreciated that a network thoroughly accomplishes that interchange via any suitable physical and non-physical layer, such as wired, wireless, or optical data communication.

The document processing engine 502 is suitably in data communication with one or more device drivers 514, which device drivers allow for data interchange from the document processing engine 502 to one or more physical devices to accomplish the actual document processing operations. Such document processing operations include one or more of printing via driver 518, facsimile communication via driver 520, scanning via driver 522 and a user interface functions via driver 524. It will be appreciated that these various devices are integrated with one or more corresponding engines associated with document processing engine 502. It is to be appreciated that any set or subset of document processing operations are contemplated herein. Document processors which include a plurality of available document processing options are referred to as multi-function peripherals.

In operation, configuration data is received by a document processing device corresponding to a configuration to be implemented thereon. Next, the document processing device commences document processing operations in accordance with the received configuration data. The received configuration data is then encrypted. Thereon, the document processing device then selectively commences the transfer of the encrypted configuration data to at least one additional document processing device via a computer network.

In accordance with one example embodiment of the subject application, a document processing device, for example a first document processing device 104, receives configuration data representing a new, modified, or updated configuration from the administrator device 128 over the computer network 102, directly via portable storage media at the first document processing device 104, or the like. It will be understood by those skilled in the art that the first document processing device 104 is used herein for example purposes only, and the subject application is capable of implementation using any of the document processing devices 104, 110, 116, or 122. The first document processing device 104 then commences document processing operations in accordance with the received configuration data. It will be appreciated by those skilled in the art that suitable configuration data is capable of including, for example and without limitation, software, hardware configurations, device drivers, data of interest, network settings information, user account information, user-interface settings, documents, or the like. In accordance with one embodiment of the subject application, the configuration data is in the form of an XML clone file.

The first document processing device 104, via the controller 108 or other suitable component thereof, then retrieves a node from the configuration data corresponding to a document processing device 110, 116, or 122 on the computer network 102. A determination is then made by the first document processing device 104 whether or not the retrieved node requires encryption. When encryption is required for the node, e.g., a node of an XML document containing sensitive information, e.g., user passwords, address book contents, or the like, the unique data associated with the node is determined. In accordance with one embodiment, such unique data includes, for example and without limitation, the unique data associated with the node, e.g., the XPATH of the node, associated with the node in the XML file. A unique encryption key is then generated using the unique data associated with the node being encrypted. Thus, in accordance with one embodiment, the XPATH of the node is used to generate the unique encryption key. It will be appreciated by those skilled in the art that any suitable method of generating the encryption key using the unique data associated with the node is capable of implementation in accordance with the subject application. The node value is then encrypted using the generated unique encryption key.

A determination is then made by the first document processing device 104 whether another node corresponding to a document processing device 110, 116, or 122 remains. When one or more additional nodes remain, the process described above is repeated until all nodes corresponding to the document processing devices 110, 116, and 122 have been accessed and analyzed. Upon a determination that no further nodes remain, the configuration data is stored by the document processing device 104, i.e., the configuration data is updated. The configuration data is then transferred to the corresponding document processing devices 110, 116, and 122 via the computer network 102.

The skilled artisan will appreciate that the subject application is capable of instituting a master-clone mode of operation wherein the first document processing device 104 functions as the master node and each of the other compatible document processing devices 110, 116, and 122 are clones, i.e., any changes made to the first document processing device 104 will be replicated by the clone document processing devices 110, 116, and 122, or a peer-to-peer mode of operation, wherein any change made to any one of the document processing devices 104, 110, 116, or 122 will be replicated indiscriminately on each of the other document processing devices 104, 110, 116, or 122. The skilled artisan will further appreciate that the use of the first document processing device 104 is for example purposes only and any of the other document processing devices 110, 116, and 122 are equally capable of functioning as a master node or the originating node in a peer-to-peer mode of operation.

It will be appreciated by those skilled in the art that the transfer operation is capable of comprising a push-type of operation or a pull-type of operation. The skilled artisan will understand that a push-type operation involves the first document processing device 104 transmitting the configuration data to each of the remaining document processing devices 110, 116, and 122 via the computer network, whereas the pull-type operation involves the remaining document processing devices 110, 116, and 122 requesting the configuration data from the first document processing device 104 via the computer network 102. The skilled artisan will appreciate that such a push is capable of being directed to a single document processing device, or any number of associated document processing devices communicatively coupled to the computer network 102.

In accordance with one example embodiment of the subject application, a document processing device, for example the second document processing device 110, receives encrypted configuration data representing a new, modified, or updated configuration from the first document processing device 104 over the computer network 102. It will be understood by those skilled in the art that the first document processing device 110 is used herein for example purposes only, and the subject application is capable of implementation using any or all of the other document processing devices 116, or 122 as the receiving document processing device. The second document processing device 110 then decrypts the received encrypted configuration data using the appropriate decryption key, i.e., the decryption key associated with the specific node corresponding to the second document processing device 110. Thereafter, the second document processing device 110 is configured in accordance with the decrypted configuration data and commences document processing operations in accordance therewith. It will be appreciated by those skilled in the art that the above-described system thereby facilitates the secure synchronization of configuration data of each compatible document process device 104, 110, 116, and 122 on the computer network 102.

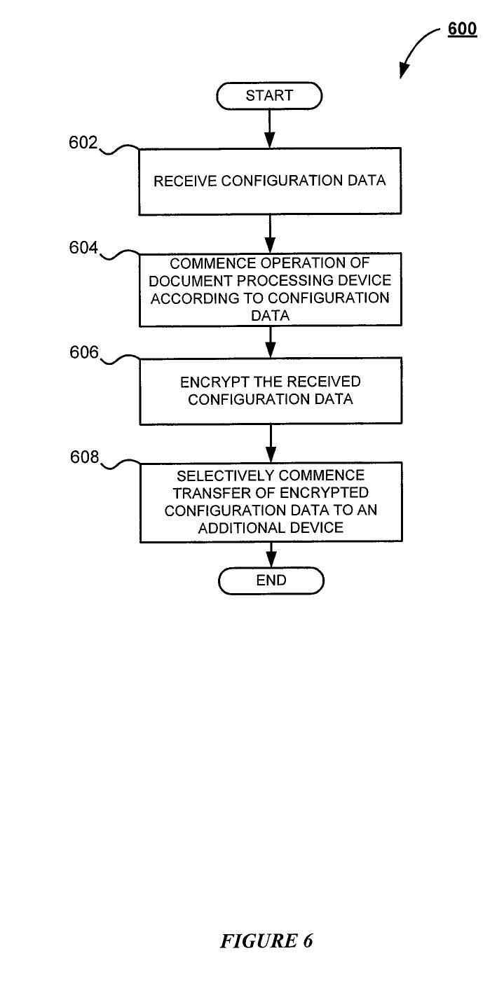

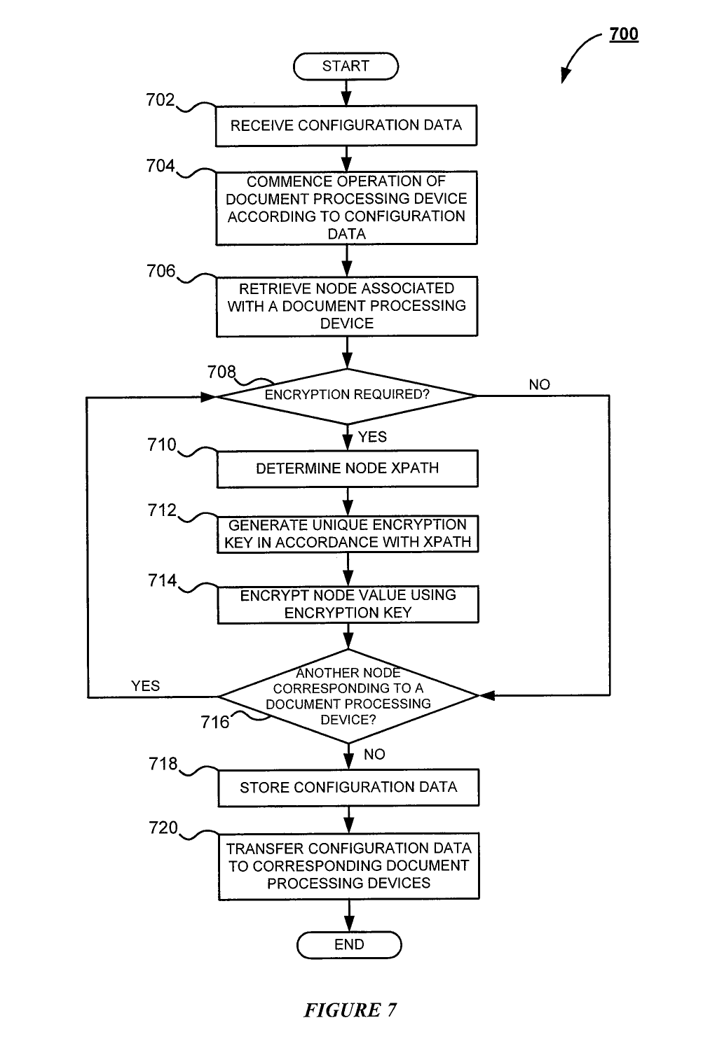

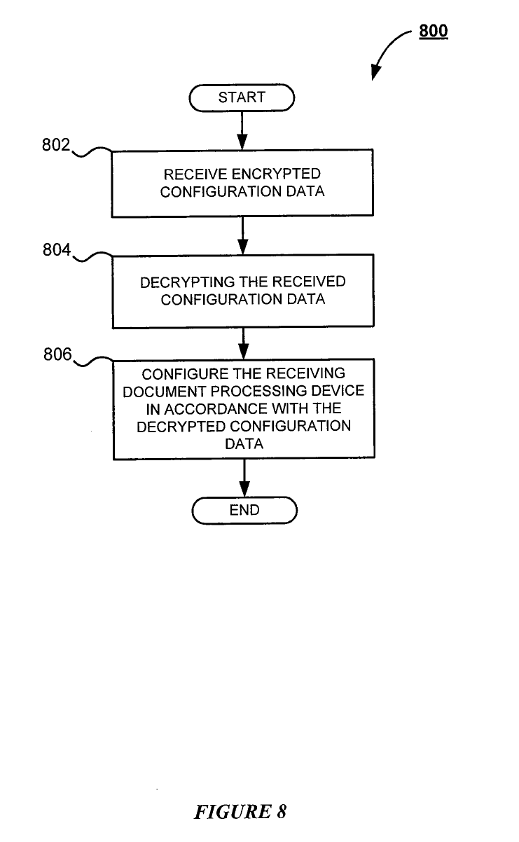

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6, FIG. 7, and FIG. 8. Turning now to FIG. 6, there is shown a flowchart 600 illustrating a method for secure sharing of configuration cloning information for document processing devices in accordance with the subject application. Beginning at step 602, a first document processing device 104 receives configuration data corresponding to a configuration thereof via a computer network 102. The first document processing device 104 then commences document processing operations in accordance with the received configuration data at step 604. At step 606, the first document processing device 104 then encrypts the received configuration data. The first document processing device 104 then, at step 608, selectively commences a transfer of the encrypted configuration data to at least one other document processing device 110, 116, or 122.

Referring now to FIG. 7, there is shown a flowchart 700 illustrating a method for secure sharing of configuration cloning information for document processing devices from an encryption point-of-view in accordance with the subject application. At step 702, a document processing device, such as the third document processing device 116, receives configuration data corresponding to a configuration of the document processing device 116 via the computer network 102. For purposes of example, reference will be made herein to the third document processing device 116 receiving the configuration data. Thus, the skilled artisan will appreciate that in accordance with the subject application, any of the document processing devices 104, 110, or 122 is equally capable of functioning as the initial document processing device to receive the configuration data. Preferably, the configuration data is received from an administrator, such as the administrator device 128, and suitably corresponds to data representative of device settings, network settings, user information, sensitive data, account information, software, hardware, user-interface, or the like.

The third document processing device 116 then commences document processing operations at step 704 in accordance with the received configuration data. In accordance with one embodiment of the subject application, the configuration data is received by the document processing device 116 in an XML format. At step 706, the controller 120, or other suitable component of the third document processing device 116, retrieves a node associated with a document processing device 104, 110, or 122 on the computer network 102. A determination is then made at step 708 whether encryption of configuration data corresponding to the node is required. When no encryption is required, flow proceeds from step 708 to step 716, whereupon a determination is made whether another node corresponding to a document processing device 104, 110, or 122 remains for analysis by the third document processing device 116. When an additional node remains, as set forth by the XML document representative of the configuration data, flow returns to step 708, whereupon the third document processing device 116 determines whether encryption for this next node is required.

When encryption is required, flow proceeds to step 710, whereupon the unique data associated with the node to be encrypted is determined. For example, in accordance with one embodiment of the subject application, the unique data associated with the node is the XPATH of the node, or the like. A unique encryption key is then generated at step 712 by the third document processing device 116 in accordance with the unique data, e.g., the XPATH, corresponding to the node. The node value is then encrypted at step 714 using the unique encryption key, thereby resulting in encrypted configuration data. When no additional nodes remain for analysis by the third document processing device 116 at step 716, flow proceeds to step 718, whereupon the encrypted configuration data is stored, i.e., the encrypted XML file is made ready for transfer to designated document processing devices. The encrypted configuration data is then transferred to the designated document processing devices 104, 110, and/or 122 at step 720. It will be appreciated by those skilled in the art that in some embodiments of the subject application, more than one attribute of a node is capable of being required so as to uniquely identify a node. Thus, in such an embodiment, rules are implemented for the ordering of the attributes in the XPATH to avoid confusion during the encryption and decryption of node values, as the skilled artisan will appreciate that while an XPATH is unique to a given node, the given node is capable of having more than one XPATH corresponding thereto. That is, the encryption in accordance with one embodiment of the subject application is accomplished using an encryption key that depends upon the XPATH that uniquely identifies the node and is constructed by canonical rules.

Turning now to FIG. 8, there is shown a flowchart 800 illustrating a method for secure sharing of configuration cloning information for document processing devices from an decryption point-of-view in accordance with the subject application. Reference will be made in describing FIG. 8 to the third document processing device 116 as the sending document processing device and the fourth document processing device 122 as the recipient document processing device. The skilled artisan will appreciate that the foregoing references are for example purposes only, and any of the document processing devices 104, 110, 116, and/or 122 are capable of functioning in either role in accordance with the subject application. Beginning at step 802, the fourth document processing device 122 receives encrypted configuration data from the third document processing device 116 via the computer network 102. Preferably, the encrypted configuration data suitably comprises, for example and without limitation, data representing a configuration to be implemented by the receiving document processing device 122. The fourth document processing device 122 then decrypts the received encrypted configuration data, e.g., the XML file, at step 804. The fourth document processing device 122 is then configured, at step 806, in accordance with the decrypted configuration data.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for secure sharing of configuration cloning information for document processing devices comprising:
means adapted for receiving, into at least one document processing device, configuration data representative of a configuration thereof;
means adapted for commencing operation of the at least one document processing device in accordance with received configuration data;
encryption means adapted for encrypting received configuration data;
transfer means adapted for selectively commencing a transfer of encrypted configuration data to at least one additional document processing device via an associated network.

2. The system for secure sharing of configuration cloning information of claim 1, further comprising:
means adapted for transferring received encrypted configuration data to the at least one additional document processing device;
decryption means adapted for decrypting received encrypted configuration data; and
means adapted for configuring the at least one additional document processing device in accordance with decrypted configuration data.

3. The system for secure sharing of configuration cloning information of claim 1, wherein the encryption means includes means adapted for encrypting received configuration data in accordance with an encryption key unique to a node associated with a document processing device.

4. The system for secure sharing of configuration cloning information of claim 3, wherein the encryption means further includes means adapted for encrypting received configuration data for each of the at least one additional document processing devices in accordance with a unique encryption key associated therewith.

5. The system for secure sharing of configuration cloning information of claim 4, wherein the transfer means includes means adapted for transferring encrypted configuration data corresponding to each unique encryption key to the additional document processing device corresponding thereto.

6. The system for secure sharing of configuration cloning information of claim 2, wherein the encrypted configuration data is in XML.

7. A method for secure sharing of configuration cloning information for document processing devices comprising the steps of:
receiving, into at least one document processing device, configuration data representative of a configuration thereof;
commencing operation of the at least one document processing device in accordance with received configuration data;
encrypting received configuration data;
selectively commencing a transfer of encrypted configuration data to at least one additional document processing device via an associated network.

8. The method for secure sharing of configuration cloning information of claim 7, further comprising the steps of:
transferring received encrypted configuration data to the at least one additional document processing device;
decrypting received encrypted configuration data; and
configuring the at least one additional document processing device in accordance with decrypted configuration data.

9. The method for secure sharing of configuration cloning information of claim 7, wherein the step of encrypting includes encrypting the received configuration data in accordance with an encryption key unique to a node associated with a document processing device.

10. The method for secure sharing of configuration cloning information of claim 9, wherein the step of encrypting includes encrypting received configuration data for each of the at least one additional document processing devices in accordance with a unique encryption key associated therewith.

11. The method for secure sharing of configuration cloning information of claim 10, wherein the step of transferring includes transferring encrypted configuration data corresponding to each unique encryption key to the additional document processing device corresponding thereto.

12. The method for secure sharing of configuration cloning information of claim 8, wherein the encrypted configuration data is in XML.

13. A computer-implemented method for secure sharing of configuration cloning information for document processing devices comprising the steps of:
receiving, into at least one document processing device, configuration data representative of a configuration thereof;
commencing operation of the at least one document processing device in accordance with received configuration data;
encrypting received configuration data;
selectively commencing a transfer of encrypted configuration data to at least one additional document processing device via an associated network.

14. The computer-implemented method for secure sharing of configuration cloning information of claim 13, further comprising the steps of:
transferring received encrypted configuration data to the at least one additional document processing device;
decrypting received encrypted configuration data; and
configuring the at least one additional document processing device in accordance with decrypted configuration data.

15. The computer-implemented method for secure sharing of configuration cloning information of claim 13, wherein the step of encrypting includes encrypting the received configuration data in accordance with an encryption key unique to a node associated with a document processing device.

16. The computer-implemented method for secure sharing of configuration cloning information of claim 15, wherein the step of encrypting includes encrypting received configuration data for each of the at least one additional document processing devices in accordance with a unique encryption key associated therewith.

17. The computer-implemented method for secure sharing of configuration cloning information of claim 16, wherein the step of transferring includes transferring encrypted configuration data corresponding to each unique encryption key to the additional document processing device corresponding thereto.

18. The computer-implemented method for secure sharing of configuration cloning information of claim 14, wherein the encrypted configuration data is in XML.
